(19) United States
(12) Patent Application Publication
(10) Pub. No.: US 2014/0180671 A1
(43) Pub. Date: Jun. 26, 2014

(54) Transferring Language of Communication Information

(71) Applicant: Maria Osipova, Moscow (RU)

(72) Inventor: Maria Osipova, Moscow (RU)

(21) Appl. No.: 13/726,526

(22) Filed: Dec. 24, 2012

(51) Int. Cl. G10L 15/00

(52) U.S. Cl. CPC G10L 15/005
USPC 704/8

(57) ABSTRACT

The invention provides a method of determining a language of communication from a processor controlled device. In one case, the language of communication is derived from language of communication information retrieved from the processor controlled device, such as, for example, GPS information. In one implementation, the method includes: determining a geographical location of the processor controlled device; determining the language of communication based on the geographical location information; and transmitting the language of communication from the processor controlled device to a resource provider. Resources from the resource provider are received by the processor controlled device in the language of communication of the processor controlled device.

### BACKGROUND OF THE INVENTION

1. Field

Embodiments of the present invention generally relate to a system, method and a computer program in the field of mobile services, data transmission, and wireless mobile communication and user interface of processor controlled devices.

2. Related Art

Mobile devices such as smartphones, mobile phones, laptops, tablet computers, netbooks, personal digital assistants, etc. are becoming increasingly available worldwide. With the increased number of devices, comes increasing communications in an increasing number of languages. Businesses and governmental entities need to effectively respond to the increasing number of languages that inquiries are being communicated in.

Business and governmental entities (such as hotels, airports, IRS, etc.) in some cases provide multi-lingual operator support for oral communications such as a call center. In other cases, communications from a customer support center may be in written form. In one example, communications are via the email across the Internet such as from an IT help desk where messages are exchanged between a user of a mobile device and a support center staff person.

A problem can occur when the operator and the caller speak different languages. For this case, the time to change from the call center support staff originally servicing the call and a call center support staff person who can speak or write in the user's preferred language of communication may be time consuming or may cause a disconnect between the IT help desk and the caller. This problem is especially critical where communications are time critical—for example, where there is an emergency.

### SUMMARY

The invention provides a method of determining a language of communication from a processor controlled device. In one case, the language of communication is derived from language of communication information retrieved from the processor controlled device, such as, for example, GPS information. In one implementation, the method for determining a language of communication of a processor controlled device includes the steps of: determining a geographical location of the processor controlled device; based on the geographical location of the processor controlled device, determining the language of communication; and transmitting the language of communication from the processor controlled device to a resource provider. Resources from the resource provider are received by the processor controlled device in the language of communication of the processor controlled device.

### BRIEF DESCRIPTION OF THE DRAWINGS

FIG. 1A shows a flowchart of operations for a method of determining the language of communication performed in accordance with an embodiment of the invention.

FIG. 1B shows a flowchart further detailing the step of determining the language of communication where geographic information is used to determine the language of communication of the processor controlled device in accordance with an embodiment of the present disclosure.

FIG. 2A shows an example of a user interface displayed on a touch screen of a processor controlled device demonstrating the list of proposed by system aims for call available for manual selecting by user in accordance with an embodiment of the present disclosure.

FIG. 2B shows an example of a user interface displayed on a touch screen of a processor controlled device demonstrating the settings available for a user in accordance with an embodiment of the present disclosure.

FIG. 2C shows an example of a user interface displayed on a touch screen of a processor controlled device demonstrating the list of proposed system languages available for manual selection by user in accordance with an embodiment of the present disclosure.

FIG. 3 shows a flowchart of operations for determining the language of communication in accordance with an embodiment of the present disclosure.

FIG. 4A shows a block diagram of the processor controlled device and the resource provider exchanging the language of communication information in accordance with an embodiment of the present disclosure.

FIG. 4B shows a block diagram of the processor controlled device and resource provider exchanging language of communication information in accordance with an alternative embodiment of the present disclosure.

FIG. 5A shows a flowchart of operations for a method of determining the language of communication performed in accordance with an embodiment of the invention.

FIG. 5B shows a flowchart of operations for a method of determining the language of communication performed in accordance with an alternative embodiment of the invention.

FIG. 6 shows an exemplary hardware for implementing the method of communicating the language of communication in accordance with an embodiment of the present disclosure.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present disclosure describes a system and method that allows a processor controlled device to transfer information about the language of communications and/or the geographical location to a resource provider. In one example, the transfer of the language of communications of the processor controlled device is transferred before resources are made available from the resource center to the processor controlled device. Assume for illustration purposes that the processor controlled device is a mobile device, such as a cellular phone and a user or caller is associated with the processor controlled device. For example, the caller (the user of the processor controlled device) may initiate a telephone call to a call center (resource center).

In one example, the language communications of the caller is communicated to the call center before beginning a conversation. Transmitting language of communication information before the direct conversation of the user and call center operator, helps eliminate delays that result when the language of communication is not known before the call is initiated by the caller. Transmitting the language of communication before the conversation begins, provides the caller with the possibility to comfortably communicate with a call center operator who speaks the same language as that of the caller.

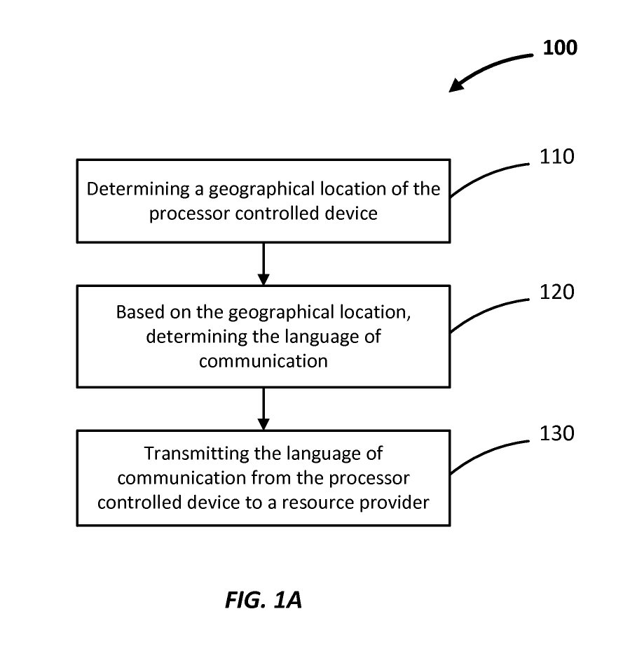

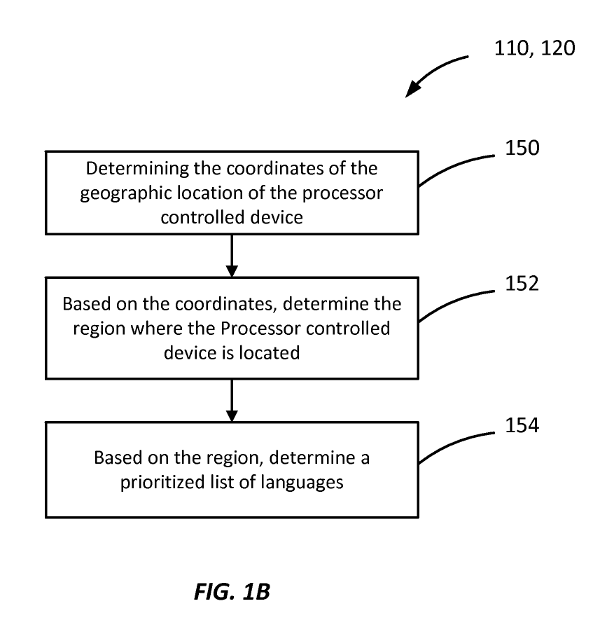

FIG. 1A shows a flowchart of operations for a method 100 of determining at least one language of communication associated with a processor controlled device performed in accordance with an embodiment of the present disclosure. Referring to FIG. 1A, the method for determining a language of communications of a processor controlled device includes the steps of: determining a geographical location of a processor controlled device (step 110); based on the geographical location of the processor controlled device, determining the language of communication (step 120); and transmitting the language of communication from the processor controlled device to a resource provider (step 130).

To avoid the above mentioned problems (e.g., delay in transferring to an operator who speaks the right language), the described system and method allows the call center to receive information about the language of communication of the caller before the beginning of a direct conversation. That is, the information about the caller's preferred language (language of communication) is transmitted to the call center. In the following description, the term language of communication will be used for indicating such information such as the language(s) of choice for the caller or user of the processor controlled device.

In one example, the language of communication is the user of the processor controlled device's native language, or alternatively, may be a language that the user of the processor controlled device feels comfortable communicating in. The term language of communication refers to the language that the communications between the processor controlled device and the resource center are transmitted in if available. In one example, the communications may be oral, written or a combination of both oral and written communications. In an alternative example, the preferred language of oral communication and written communication may be different from each other.

The language of communication is useful for selection of the appropriate operator in the support center such that the operator speaks the same language as the caller utilizing the mobile device. Thereby timely received information helps to improve the quality of work of support centers and the service rate and quality of service provided to the users. Other kinds of information about the caller also can be transferred to the support center. This information can help to establish the exact location of a caller thereby simplifying the tasks of navigation, directing services to the caller, etc.

A step in the method for determining a language of communications of a processor controlled device is determining a geographical location based on language of communication information retrieved from the processor controlled device (step 110). In one example, the language of communications is determined based on information about the geographical location of the processor controlled device. In one example, if is detected that the processor controlled device (caller) is physically located in the United States, then the English language is automatically selected as the language of communication.

In one example, the processor controlled device is a mobile or cellular telephone that includes a GPS navigation device, circuit or circuitry. Geographical location may be determined in processor controlled devices that include navigational functionality such as a Global Positioning System (GPS) module, a Global Orbiting Navigation Satellite System (GLONASS) module, a Global System for Mobile Communications (GSM) module or circuitry, Global Digital Mapping Alliance (GDMA) or other types of navigation modules or circuitries. Data from navigational modules that are integrated onto the processor controlled device can be used for determining the region or country where the user (processor controlled device) is physically located. For example, geographic information retrieved from the processor controlled device's GPS navigation module can be read and the navigation information read from the GPS navigation module can be used to calculate the geographical location of the processor controlled device.

In one example, software that is installed on the processor controlled device is used to calculate the geographic location. In another example, data from the navigational modules may be transmitted to a geocoding service to determine the region or country where the processor controlled device is located.

In another example, the processor controlled device is a mobile device that does not include a navigational module or does not have Internet connectivity. For this case, instead of the geographical location being calculated from GPS coordinates that are read from the GPS navigation module installed on the processor controlled device, the geographical location is derived from cellular tower information that is retrieved from cellular towers in the vicinity of the processor controlled device. In one example, the location coordinates of the two nearest cell towers is found and triangulation is used to determine the geographical location of the processor controlled device.

FIG. 1B shows a flowchart of determining a language of communication based on geolocation data further detailing the steps 110 and 112 of FIG. 1A. Referring to FIG. 1B shows the step of determining a geographic location of the processor controlled device where the geographic location is determined using geographic information associated with the processor controlled device. In one example, the geographic information is information that is retrieved from a navigation module, such as a GPS device, that is integrated onto the processor controlled device. In another example, the geographic information is retrieved from cellular towers that track the location of the processor controlled device.

A step in determining the geographic location of the processor controlled device is determining one or more coordinates related to the geographic location of the processor controlled device (step 150). In one example, the geographical coordinates are retrieved from a navigation module that also encompasses logic for requesting and receiving geographic location data from other devices such as a network server that may track the geographic location of an electronic mobile device.

Next, at step 152, based on the geographical coordinates, the country or region where the processor controlled device is located is determined. In one example, the determination is made using correspondence tables and/or databases which associate geographical coordinates with physical locations. Based on the correspondence between the geographical coordinates acquired from navigation module of the processor controlled device, the associated country or region can be determined. The system searches for the country or region that corresponds to the geographical coordinates acquired from the navigation module of the device.

The country/region detected at the step 152 can be used to determine a prioritized list of languages. This list is generated by searching and comparing the country/region with correspondence tables or databases that match country regions to languages in the region. In one example, the list generated is a list of languages that are used or preferred in the particular country or region corresponding to the current location of the processor controlled device.

In one example, languages in the list may be arranged according to how widely each language is used in the identified region or country. In one example, the list of languages is prioritized so that the highest ranked language is the most commonly used language in the country or region. For example, the most widely used language may be listed first place on the list and should be suggested as the most probable language for recognition.

For purposes of example, suppose that the navigation module determines that the location of the processor controlled device (user) is Belgium (Kingdom of Belgium). According to a correspondence table there are three official languages in Belgium: French, Dutch and German. Also, there are regional languages: West Flemish, East Flemish, Brabantian, Limburgish, Walloon, Picard, Champenois, Lorrain, and Low Dietsch. However, the most spoken language is Dutch. So, in the described list of languages for recognition, Dutch would take the first place as the most common used language in Belgium.

Any variety of data, metrics and preferences may be combined with the geolocation data to sort and arrange a list of languages to be used for recognition. One example of such other data may be a set of historical geolocation data. For example, if a traveler is fond of traveling to and staying in French speaking regions or countries (prior to entering Belgium), the list of languages for the particular device (and user) may be rearranged so that French appears as the first or preferred language for recognition.

In another example, determining the language of communication may be based instead of on the current physical location of the processor controlled device (based on GPS, cell tower location information)—may be based on the country of first registration by user. For example, if the processor controlled device is registered first in Russia, the system may automatically assign the language of communication to be Russian.

Referring to FIG. 1A, after determination of the language of communication, the language of communication is transmitted from the processor controlled device to a resource provider (step 130). For purposes of illustration herein, the example of a call center is used as an example of a resource provider. Although a call center is used as an example, any entity which provides resources responsive to a request of a processor controlled device or its user may be referred to as a resource provider. In the call center example described, the resources provided include at least accessibility to a call center operator. However, resources from the call center may be in different forms including but not limited to oral, written or visual forms. For example, the call center could support an international hotel chain. Not only could the call center operator speak the preferred language of communication of the caller, but the operator could also provide written descriptions of the room, video, photographs—all if available in the callers preferred language of communication.

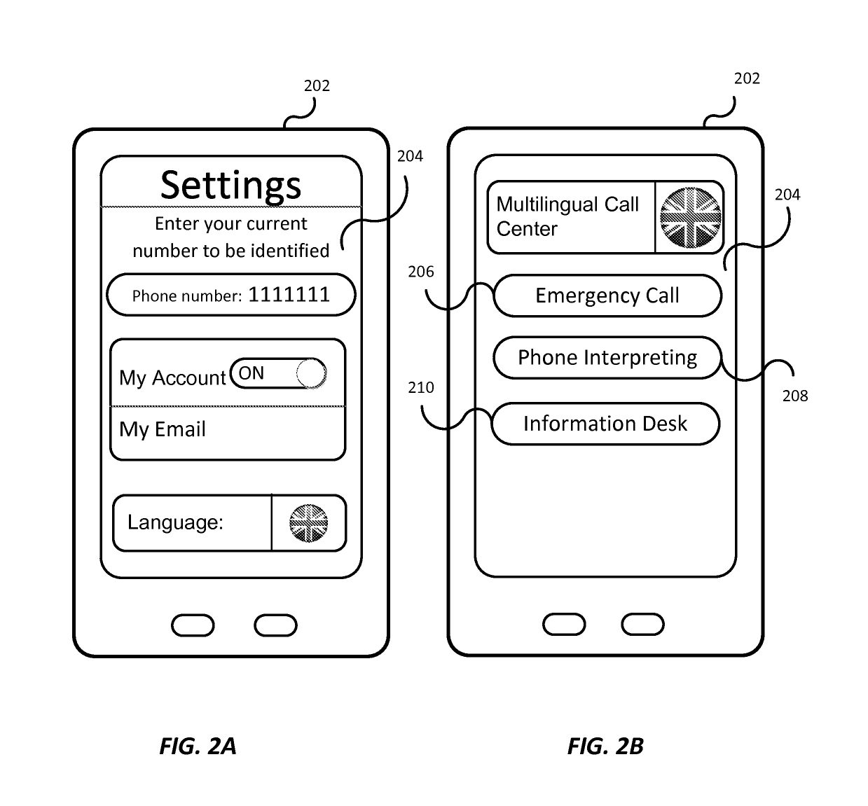

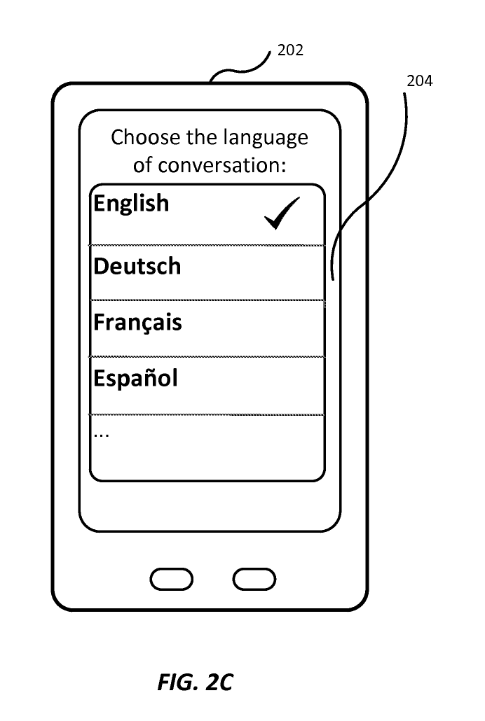

Referring now to FIGS. 2A, 2B and 2C, these figures show an example of a processor controlled device 102 that includes a display screen 104. The processor controlled device 102 may be for example, a general purpose computer embodied in different configurations. A processor controlled device 102 can be a smartphone, mobile phone, cell phone, laptop computer, tablet computer, music player, in-dash automobile computer system, in-home computer system, heating-venting-air-conditioning (HVAC) computer system, process control (PC) system operating in a chemical plant, or other processor controlled device having a display screen and supporting communications with cellular operators.

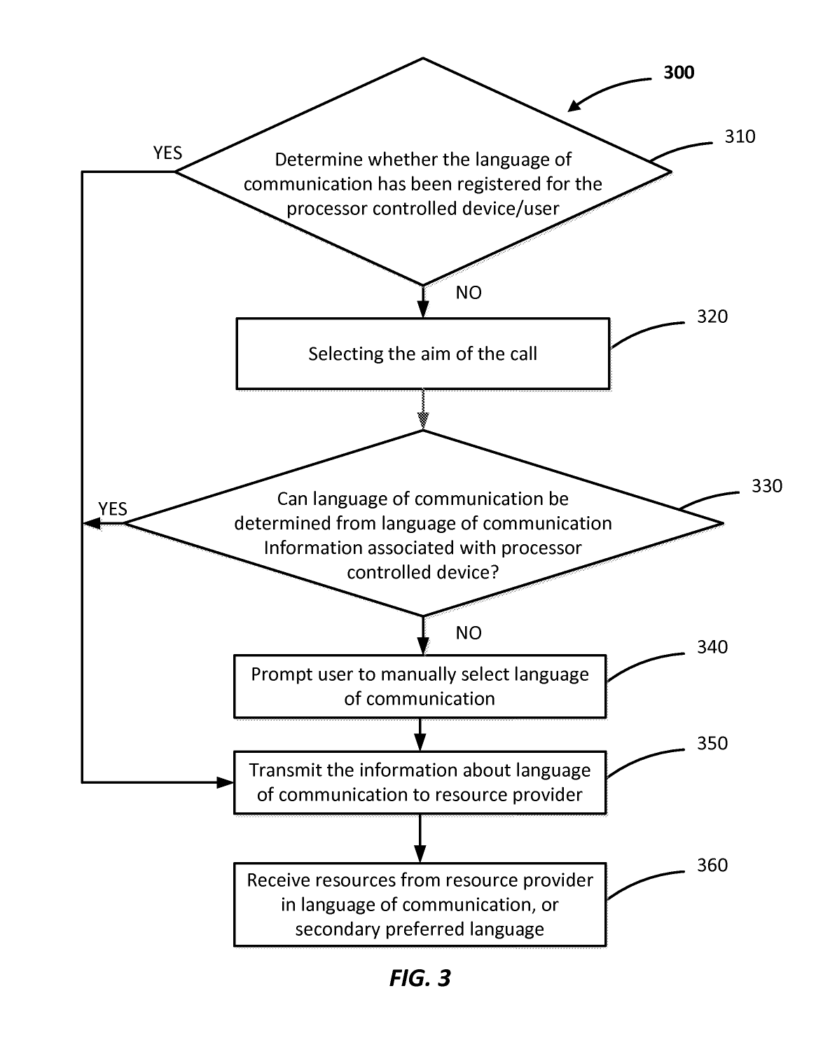

FIG. 3 shows a flowchart of operations 300 for determining the language of communication of a processor controlled device, as for example the one shown in FIGS. 2A-2C in accordance with an embodiment of the present disclosure. The method 300 shown in FIG. 3 includes the steps of: determining whether a language of communications is registered for the processor controlled device (step 310); responsive to a determination that a language of communications has not been registered, determining the language of communication based on language of communication information associated with the processor controlled device, wherein the language of communication language associated with the processor controlled device includes at least one of the following: geographic location information, language file analysis information and default language of user interface of the processor controlled device (step 330); and transmitting the language of communication to a resource provider, wherein the resources assigned to the processor controlled device is in the language of communications if available (step 350).

Referring to FIG. 3, the method 300 for determining the language of communication of a processor controlled device includes the step of determining whether a language of communications is registered for the processor controlled device (step 310). In one example, registration of the language of communications of the processor controlled device is optional. In one example, upon initialization, a processor controlled device may prompt the user to register different aspects associated with the processor controlled device. For example, referring to FIG. 2A, the device 202 shows confirming through a graphical user interface 204 a mobile phone number of 111111. In one example, upon system initialization, the user may manually input a settings function, which may include the use or entering of the phone number. After registration, the mobile phone number may be used for identification of the user.

In an alternative example, the user can specify the language of communication of the processor controlled device. As shown in FIG. 2C, the English language is selected as the language of communication. The registration is optional, but it can be useful in identifying the user to a system that it communicates with in the future (for example, a call center). Other unique or semi-unique identifiers also may be used, for example an International Mobile Equipment (IMEI), may be used as a unique identifier. In another example, the user may optionally register the processor controlled device using an email address as a unique identifier. In one example, registration is performed at initialization of the mobile device or after a change of the Subscriber Identity Module (SIM) card for a mobile device. All information about the user for the corresponding mobile device can be stored in the system of the resource provider and can be associated with the unique or semi-unique identifier. After accessing the account the initial time, the user no longer needs to specify the appropriate language of communication. In another example, the first time the mobile device calls the resource provider, the mobile device phone number may be automatically detected by a resource provider. The mobile device phone number may then be used as a user ID in resource provider's system.

In one example, the method 300 includes the optional step of determining the aim of the communication (step 320). For the example where a resource provider is a call center, step 320 would be to determine the aim of the phone call made by the processor controlled device. Referring to FIG. 2A, in one example the processor controlled device 202 prompts the user and allows the caller to choose the aim of the call using an element of the graphical user interface before a conversation occurs. Referring to the prompt shown in FIG. 2B, there are three different aims or purposes that may be chosen by the mobile device user: emergency call 206, phone interpreting 208, and information desk 210. In another example, different aim choices may be provided to the mobile device user.

In one example, different priorities are assigned responsive to the aim selected by the user. For example, the emergency call may have the highest level of priority in order to contact the resource provider most quickly to provide emergency assistance (resources) to the caller using the processor controlled device 202. For example, if there is only a single Spanish speaking operator available and an emergency call requires a Spanish speaker, the single Spanish speaking operator will be assigned immediately to the emergency call 206. In one example, the aim of the call is translation services 208. In this case, the aim of the call (e.g., Phone Interpreting 208) is chosen (step 320). In one example, two languages should be specified: the source language and the target language.

The processor controlled device in one example is also able to identify the translation direction automatically or language of communication can be determined from language of communication Information associated with processor controlled device (step 330). In one example, the target language may be identified based on geolocation data and the source language may be determined based on the language of the user interface of the mobile device. For example, if the user interface of the application or mobile device is in the Russian language, the Russian language may be specified as the source language. If the call is made to a call center physically located in the USA, English may be the language as target language for translation. In another embodiment, the source and the target language for translation may be manually preset by a user in the settings of the system.

Any kind of translation supported by the resource provider may be provided by the call center. In one example, an oral translation of a phone conversation between a single caller and the call center operator may be provided. In another example, translation is of an oral translation of a conference call or alternatively a translation of face-to-face conversation among a group of persons. In the case of a face-to-face conversation, the call center operator may translate with help of a speaker phone.

In one example, the aim of the call is information services. In this case, the aim (Information Desk) will be selected by the user (step 320). In one example, getting reference information through the “Information Desk” may be provided in two ways: in real time and not in real time. The option of receiving information in real time and interacting with an operator may be chosen when the information is needed quickly, i.e., for communicating with attendants of hotels, shops, airports or with a dispatcher for calling a taxi, etc. By real time, it means that the caller interacts with an environment or resource (e.g., the call center operator, automated call system) at the moment the call is being made so that the caller speaks and listens live or in an interactive regime. In one example, the reference information is supplied by the call center operator responsive to the caller's written or oral request. For example, the caller may be calling the call center of a hotel and in response to his verbal request for information about the hotel's menu, the hotel call center operator may send via an email message the hotel menu (an additional resource) to the caller's mobile phone.

In another example, the reference information is not delivered in real time. In one example, the caller is interacting with an automated computer program during the call. In one example, the interaction may be described as receiving reference information that does not requiring intervention of a human: i.e., a currently prevailing rate of exchange, weather forecast, location of municipal objects, size of clothes, information about transport, train/bus schedules, telecommunication opportunities (area code, trunk calls, interurban calls) and so on.

Referring to FIG. 3, the method 300 includes the step of: determining that a language of communications has not been registered 310. If a language of communication has not been registered then the language of communication is determined based on language of communication information associated with the processor controlled device (step 330). Alternatively, if the language of communication has not been registered then the language of communication can be determined based on information associated with a unique or semi-unique ID that can be associated with the processor controlled device. In one example, the unique ID is a phone number that is associated with a SIM card. The language of communication information associated with the processor controlled device includes at least one of: geographic location information, language file analysis information, default user interface language (step 330).

The language of communication information associated with the processor controlled device can be used to determine the language of communication. One example of language of communication information that is associated with the processor controlled device could be information, such as files saved on the processor controlled device or files that are accessible by the processor controlled device, such as say for example a file in the cloud in an account associated with a user or user information accessible by or registered (configured) on the processor controlled device.

In one example, the type of language of communication information that is used to determine the language of communication is geographical information. For example, as previously discussed the geographical information could be GPS navigation information or cell tower information. In both cases, the GPS or cell tower information can be used to determine a geographical location. Based on the geographical location, a likely language of communications is determined.

In another example, the language of communication is automatically performed based on language of communication information about the default language of the graphical user interface (GUI) of an application. The language of the user interface of the application may be installed in advance and in one example is assumed to be the same as the language of the user interface of the processor controlled device. So if the default language of the mobile device is Russian, then the language of the user interface is also the Russian language. As a result it is supposed that the native language of user (language of communication) is Russian, thereby the setting of Russian language also may be performed automatically.

In one example, the type of language of communication information that is used to determine the language of communication is language file analysis information. In one example, an application stored on the processor controlled device could have files stored on the processor controlled device. In one example, email files (attachments, email client mailbox file, etc.) or Short Message Service (SMS) messages may be stored on the processor controlled device. In one example, emails and SMS in the sent tray are analyzed to determine the language used. Since the user is likely to send messages in a language that he or she feels comfortable using, then the assumption can be made that the language of communication is the same language as the language of the files in a sent folder.

In one example, the email messages or SMS messages are written in a secondary alphabet such that the messages are transliterated. For example, Russian words may be written not in a Cyrillic alphabet, but in a Roman alphabet. The system can match each word in an SMS message or email message to a word or expression in a dictionary. If the word is not found in the Roman alphabet then it may be written so that it is transliterated and matched to identify a language.

Analyzing the contents of a processor controlled device may also include analyzing contacts in a telephone directory or email contact list. Based on the codes of phone numbers in the telephone directory of the contacts, the language of communication of the user may be determined. According to results of analyzing the user's telephone directory, some hypotheses of language of communication {L₁, L₂, . . . Lₙ} may be formulated.

In one example, the type of language of communication information that is used to determine the language of communication is language file analysis information. In one example, an application stored on the processor controlled device could have files stored in a memory or a storage component of the processor controlled device. In this case, the files stored in the processor controlled device could be analyzed to determine the language of the files associated with the application. Based on the language of the files, the language of communication is determined. In an alternative example, the files to be analyzed are stored in the cloud or network-accessible location. The files so stored, can be read to determine the language of communication that is primarily used in accessing the files, opening the files, modifying the files, etc. Analyzing this type of file using the language file analysis information is used to determine a preferred language of communication.

In one example, the method 300 shown in FIG. 3 optionally includes a step of prompting the user to manually select the language of communication (step 340). For the case where the language of communication is not automatically identified (such as by using the language information associated with the processor controlled device), the user may be prompted to manually select a language of communication (step 340). The manual selection of the language of communication may also be performed in the case when the automatically identified language is not a language supported by the resource provider. In one example, information about languages that are supported by the resource provider is provided in the user prompt as shown in FIG. 2C.

In one example, some subset of the languages (Chinese, Japanese, etc.) may be not available around-the-clock and the time when these languages are available may optionally be displayed in the display of the system during the times when such languages are available. Such times are shown according to the timezone and time format of the processor controlled device. For example, information “Servicezeiten, Montag—Freitag, 10-19 Uhr” may be displayed near the option for choosing language of communication—“Deutsch”. This means that call center operators who speak the German language are available only Monday to Friday, from 10 AM till 7 PM. In one example, at least one twenty-four-hour language supported by the resource provider for the user, for example, the English language, should be available to the user and the processor controlled device.

In one example, manual selection of more than one language is permitted. The selection of several languages may be preferable for avoiding the situation where a caller may need to wait for a call center operator having the same language of communication as the user. The priority of the chosen languages may be also specified. In one example, if an operator speaking the language of communication having the first priority (the preferred language of communication) is not available, the caller is automatically transferred to an operator whose language of communication is the caller's second priority language of communication.

Referring to FIG. 3, the method 300 includes the step of transmitting the language of communication to a resource provider 350, wherein the resources assigned to the processor controlled device are in the language of communications if available (step 350). In addition, parameters other than the language of communication that are related to the user (e.g., translation direction, geographical location, types of calls and identifier of user) may also be transmitted to the resource provider.

In one example, the information about the language of communication may be transferred to the resource provider simultaneously with the call over the Internet protocol, Short Message Service (SMS) or Data Tone Multiple Frequency (DTMF) codes, for example. For data transmission through the Internet, the hyper-text markup language (HTTP) protocol may be used, for example. The data may be sent with a Power-On Self Test (POST) request. SMS or DTMF codes may be used for data transmission in the circumstances when the Internet connection is absent or not stable. Also in the circumstance where no Internet connection is available, the user can be directed to the IVR (Interactive Voice Response) where all options are available for selecting.

Referring to FIG. 3, after the step of transmitting the language of communication to a resource provider 350, wherein the resources assigned to the processor controlled device are in the language of communications if available (step 350), resources are received from the resource provider (step 360). In one example, the resources are assigned based on the language of communication. In one example, a time limit for receiving the response from the resource provider may be set. For example, a time limit of five seconds may be set as the maximum time that a user may be kept waiting for a response.

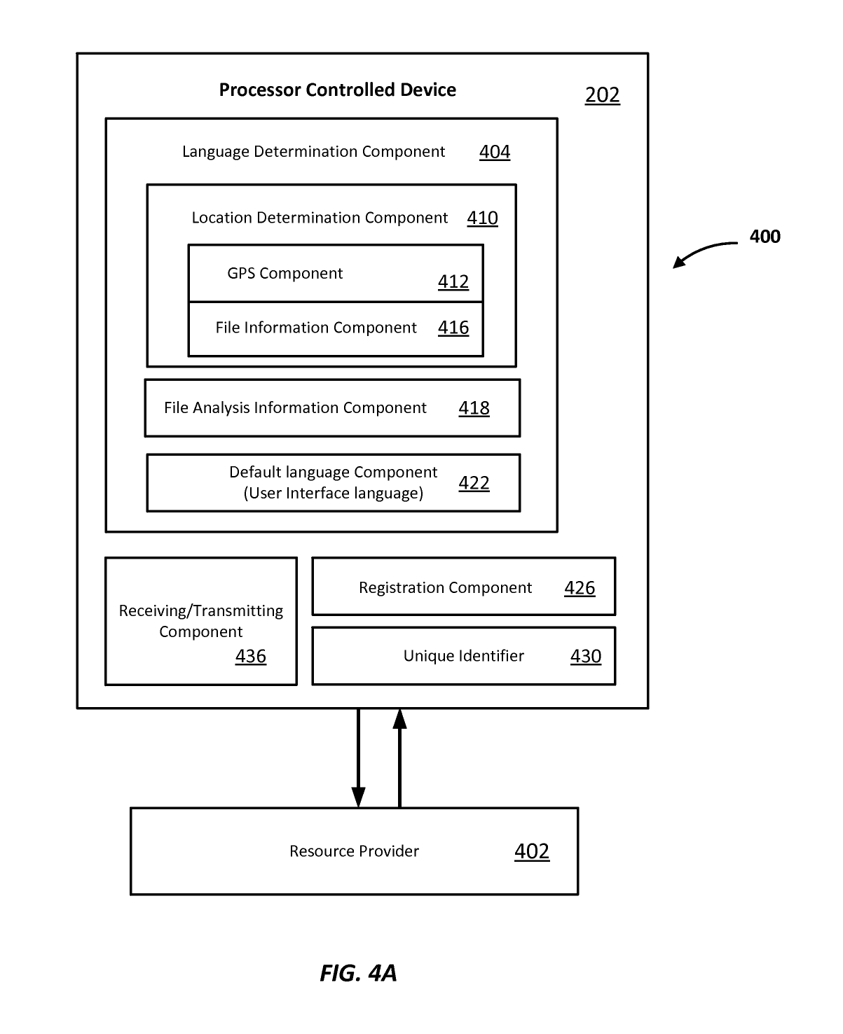

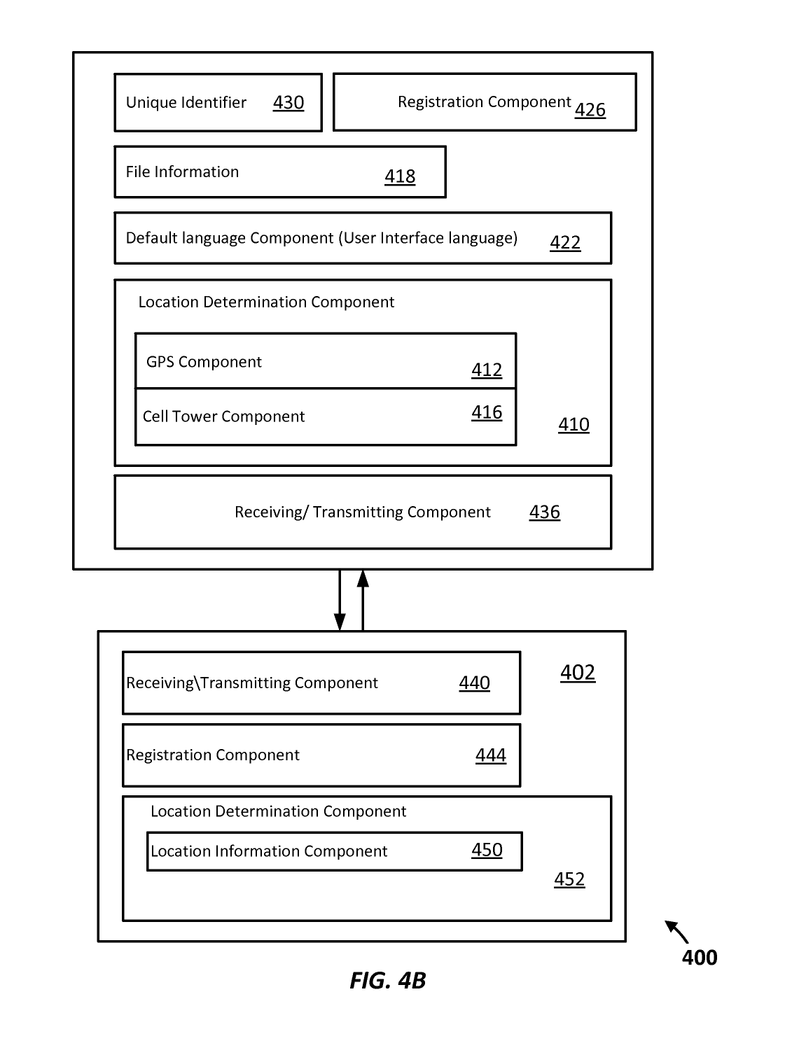

FIG. 4A shows a block diagram the processor controlled device and the resource provider exchanging language of communication information in accordance with one implementation. FIG. 4B shows a block diagram of the processor controlled device and resource provider exchanging language of communication information in accordance with an alternative implementation of the present disclosure.

In one example, the implementation shown in FIG. 4A shows an implementation where language of communication information is used by a method such as described in FIGS. 1A, 1B and 3 to determine the language of communication. In one example, the method may be implemented in 1) software, 2) hardware or 3) a combination of both hardware and software that is embedded on the processor controlled device 202. In the block diagram shown in FIG. 4A, the processor controlled device 202 transmits the language of communication to the resource provider. The resource provider 402 then uses its knowledge of the language of communication to determine the language of communication of the resources that it provides/transmits back to the processor controlled device according to the methods described in FIGS. 1A, 1B and 3.

Referring to FIG. 4A, the processor controlled device 202 includes a language determination component that functions to fulfill the method shown in FIGS. 1A, 1B and/or FIG. 3. For example, the language determination component 404 determines the language of communication (step 120, step 330). In one example, the language of communication may be derived from the geographical location of the processor controlled device. For example, information from the GPS Component 412 or the Cell Tower Component 416 of the Location Determination Component 410 can be used to determine the geographical location or alternatively information received from cell towers and can be used to determine the geographic location of the processor controlled device. In one example, the GPS Component 412 may include a GPS navigation module and software for processing GPS location coordinates. Based on the geographic location, the language determination component 404 can determine the language of communication.

Similarly, the language of communication can be determined from file analyzing information (or component) 418 stored on the processor controlled device or on memory associated with the processor controlled device. File Information or a file information component 416 from for example, SMS messages in a sent folder, file or file location, may be used by the language determination component 404 to determine the language of communication. Also the language of communication can be determined based on language of user interface that may be stored in the Default Language Component 422 of the processor controlled device 402. The Unique Identifier 430 and the Registration Component 426 can be used to identify the user and its associated processor controlled device. The Registration Component 426 can in some cases also provide language of communication information.

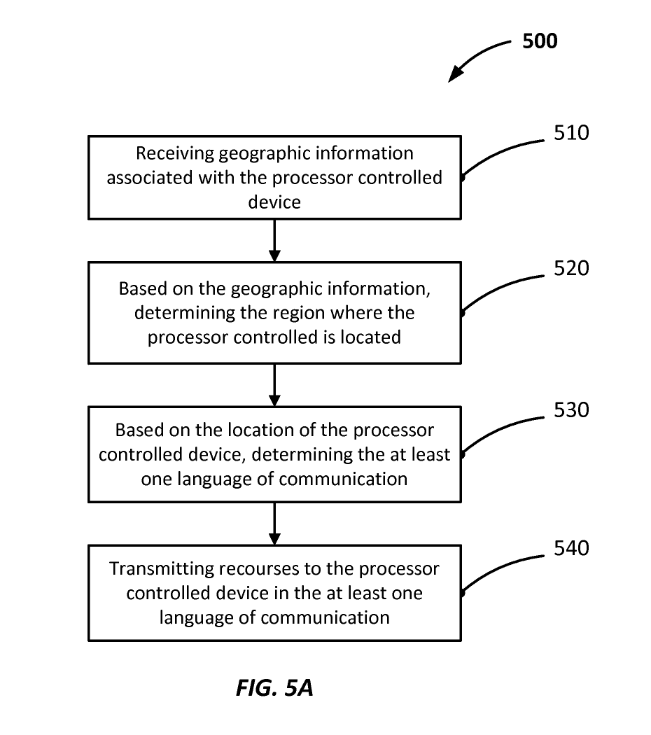

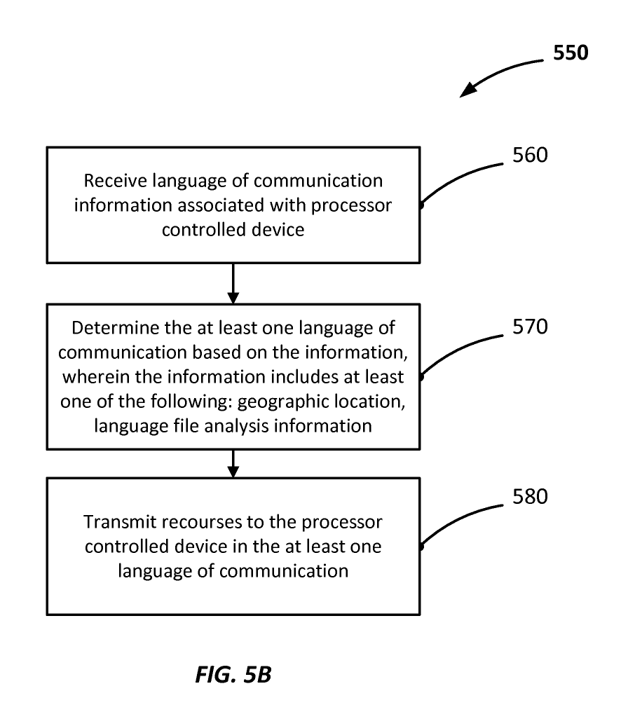

In the implementation shown in FIG. 4B, instead of the processor controlled device transmitting the language of communication to the resource provider—the processor controlled device 202 transmits language of communication information to the resource provider 402. The resource provider uses the transmitted information to determine the language of communication. In one example, the language of communication information transmitted to the resource provider from the processor controlled device is geographic information according to the method shown in FIG. 5A.

Referring to FIG. 4B, information from the processor controlled device 202 may be transmitted to the resource provider 402. In this case, the language of communication may be determined by the resource provider. For the case where the resource provider determines the language of communication, the method for determining the language of communication shown in FIGS. 1A, 1B and 3 changes. A step of receiving information associated with processor controlled device by the resource provider is needed. Instead of the processor controlled device determining the language of communication, this determination is now done by the language determination component 452 of the resource provider.

Referring to FIG. 5A, for this case the method 500 for determining at least one language of communication is comprised of the steps of: receiving geographic location information from the processor controlled device (step 510); based on the geographic location information received from the processor controlled device, determining the region where the processor controlled device is located (step 520); based on the physical location of the processor controlled device, determining the at least one language of communication (step 530); and transmitting resources to the processor controlled device, wherein the resources transmitted to the processor controlled device are in the at least one language of communications if available (step 540).

Referring to FIG. 4B, the language determination component 452 of the resource provider 402 then uses the language of communication information from the processor controlled device 202 to derive or otherwise determine the language of communication. For example, consider the case where the processor controlled device transmits GPS navigational data from the GPS Component 412 to the resource provider 402. The Location Determination Component 450 of the Language Determination Component 452 could then determine the language of communication from the GPS information. In one example, the method shown in FIG. 1B could be utilized by the Location Determination Component 450 such that the GPS coordinates could be used to determine the region the processor controlled device is located (step 152). Then based on the region the processor controlled device is located, the language of communication is determined.

In an alternative implementation of the FIG. 4B, the processor controlled device 202 transmits language of communication information to the resource provider 402 where the language of communication information could be for example, geographic location information or language file analysis information. Referring to FIG. 5B shows a method where the language of communication information is geographic location information. For this case the method (step 550) for determining at least one language of communication is comprised of the steps of: receiving language of communication information associated with the processor controlled device (step 560); determining the at least one language of communication of the processor controlled device based on the language of communication information, wherein the language of communication information includes at least one of the following: geographic information, language file analysis information (step 570); and transmitting resources to the processor controlled device, wherein the resources transmitted to the processor controlled device are in the at least one language of communications if available (step 580).

Referring to FIG. 4B, the language of communication can be determined from file analyzing information 418 stored on the processor controlled device or on memory associated with the processor controlled device can be transmitted from the processor controlled device 202 to the resource provider 402. File Information 418 from for example, SMS messages in the sent file or sent folder, may be used by the language determination component 404 to determine the language of communication. In one example, the language of the SMS messages in the sent file is analyzed and the language of the SMS messages is assumed to be the language of communication.

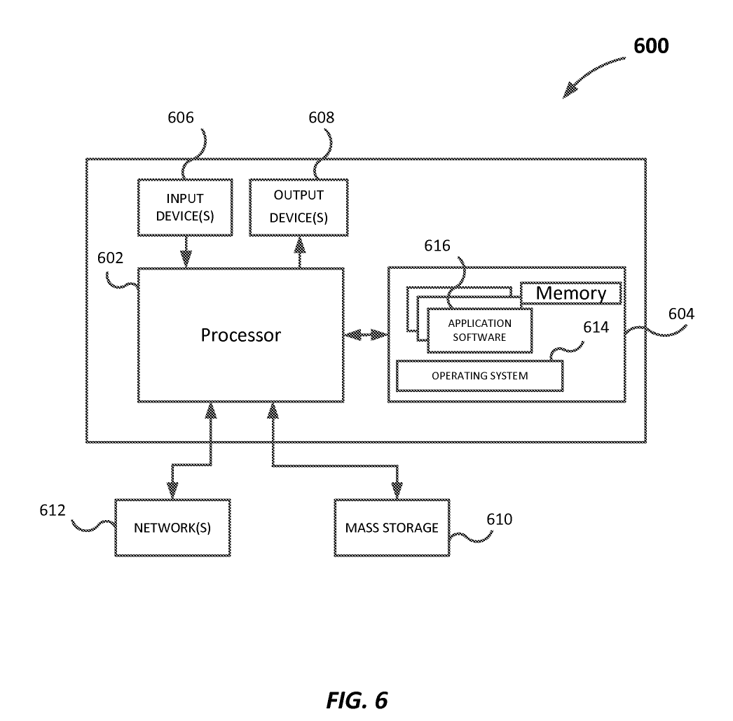

FIG. 6 of the drawings shows hardware 600 that may be used to implement the user processor controlled device 102 in accordance with one embodiment of the invention. Referring to FIG. 6, the hardware 600 typically includes at least one processor 602 coupled to a memory 604 and having a display screen among output devices 608 which in this case is serves also as an input device 606. The processor 602 may be any commercially available CPU. The processor 602 may represent one or more processors (e.g. microprocessors), and the memory 604 may represent random access memory (RAM) devices comprising a main storage of the hardware 600, as well as any supplemental levels of memory, e.g., cache memories, non-volatile or back-up memories (e.g. programmable or flash memories), read-only memories, etc. In addition, the memory 604 may be considered to include memory storage physically located elsewhere in the hardware 600, e.g. any cache memory in the processor 602 as well as any storage capacity used as a virtual memory, e.g., as stored on a mass storage device 610.

The hardware 600 also typically receives a number of inputs and outputs for communicating information externally. For interface with a user or operator, the hardware 600 usually includes one or more user input devices 606 (e.g., a keyboard, a mouse, imaging device, scanner, etc.) and a one or more output devices 608 (e.g., a Liquid Crystal Display (LCD) panel, a sound playback device (speaker). To embody the present invention, the hardware 600 must include at least one screen device (for example, a touch screen), an interactive whiteboard or any other device which allows the user to interact with a computer by touching areas on the screen. The keyboard is not obligatory in case of embodiment of the present invention.

For additional storage, the hardware 600 may also include one or more mass storage devices 610, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 600 may include an interface with one or more networks 612 (e.g., a local area network (LAN), a wide area network (WAN), a wireless network, and/or the Internet among others) to permit the communication of information with other computers coupled to the networks. It should be appreciated that the hardware 600 typically includes suitable analog and/or digital interfaces between the processor 602 and each of the components 604, 606, 608, and 612 as is well known in the art.

The hardware 600 operates under the control of an operating system 614, and executes various computer software applications 616, components, programs, objects, modules, etc. to implement the techniques described above. Moreover, various applications, components, programs, objects, etc., collectively indicated by reference 616 in FIG. 6, may also execute on one or more processors in another computer coupled to the hardware 600 via a network 612, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. Another type of distribution may be implemented as Internet downloads.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

I claim:

1. A system for determining at least one language of communication associated with a processor controlled device, the system comprising:
one or more processors;
one or more electronic data storage devices; and
computer instructions stored in the one or more electronic data storage devices that when executed by one of the one or more processors, control the system to:
determine the language of communication based on language communication information associated with the processor controlled device, wherein the language of communication information associated with the processor controlled device includes at least one of the following: geographic information, language file analysis information, default language of user interface of the processor controlled device; and
transmit the at least one language of communication information from the processor controlled device to a resource provider, wherein the at least one language of communication is transmitted to the resource provider before resources are provided to the processor controlled device.

2. The system recited in claim 1 wherein the language of communication information associated with the processor controlled device is file analysis information, wherein the file analysis is based on the analysis of files related to sent messages.

3. The system recited in claim 1 wherein the geographic information retrieved from the processor controlled device is GPS navigation information read from the GPS navigation device, wherein the GPS navigation information is used to calculate the geographic location of the processor controlled device.

4. The system recited in claim 1 wherein the processor controlled device includes a phone capable of cellular communication and further wherein the geographical information retrieved from the processor controlled device is cell tower information from cell towers in the vicinity of the processor controlled device and wherein the cell tower information is used to calculate the geographic location of the processor controlled device.

5. The system recited in claim 1 wherein the resource provider is a support center and the resource being provided is access to a support representative capable of speaking the at least one language of communication.

6. The system recited in claim 1 further wherein the assigned resources from the resource provider are received by the processor controlled device, wherein the resources assigned to the processor controlled device is in the at least one language of communications if available.

7. A method for determining at least one language of communication associated with a processor controlled device, the method comprising the steps of:
determining at least one language of communication based on language communication information associated with the processor controlled device, wherein the language of communication information associated with the processor controlled device includes at least one of the following: geographic information, language file analysis information; and
transmitting the language of communication information from the processor controlled device to a resource provider, wherein the at least one language of communication is transmitted to the resource provider before resources are provided to the processor controlled device, wherein the resources assigned to the processor controlled device is in the at least one language of communication.

8. The method recited in claim 7 further including the step of determining whether the at least one language of communications is registered for the processor controlled device, wherein the step of determining whether the at least one language of communication is registered is performed before the step of determining the at least one language of communication.

9. The method recited in claim 7 wherein the language of communication information associated with the processor controlled device is file analysis information, wherein the file analysis is based on the analysis of files related to sent messages.

10. The method recited in claim 7 wherein the geographic information retrieved from the processor controlled device is GPS navigation information read from the GPS navigation device, wherein the GPS navigation information is used to calculate the geographic location of the processor controlled device.

11. The method recited in claim 7 wherein the processor controlled device includes a phone capable of cellular communication and further wherein the geographical information retrieved from the processor controlled device is cell tower information from cell towers in the vicinity of the processor controlled device and wherein the cell tower information is used to calculate the geographic location of the processor controlled device.

12. The method recited in claim 7 wherein the resource provider is a support center and the resource being provided is access to a support representative capable of speaking the at least one language of communication.

13. A system for determining at least one language of communication associated with a processor controlled device, the system comprising:
one or more processors;
one or more electronic data storage devices; and
computer instructions stored in the one or more electronic data storage devices that when executed by one of the one or more processors, control the system to:
receive language of communication information from the processor controlled device;
determine the language of communication based on language communication information associated with the processor controlled device, wherein the language of communication information associated with the processor controlled device includes at least one of the following: geographic information, language file analysis information; and
transmit resources to an processor controlled device, wherein the resources transmitted to the processor controlled device are in the at least one language of communications.

14. A system for determining at least one language of communication associated with a processor controlled device, the system comprising:
one or more processors;
one or more electronic data storage devices; and
computer instructions stored in the one or more electronic data storage devices that when executed by one of the one or more processors, control the system to:
determine a geographical location of the processor controlled device;
based on the geographical location of the processor controlled device, determine the at least one language of communication;
transmit the language of communication information from the processor controlled device to a resource provider, wherein the at least one language of communication is transmitted to the resource provider before resources are provided to the processor controlled, wherein the resources assigned to the processor controlled device are in the at least one language of communication.

15. The system recited in claim 14 further including the computer implemented steps of: determining the coordinates of the geographic location of the processor controlled device, and determining the region where the processor controlled device is physically located based on the coordinates of the geographical location of the processor controlled device.

16. The system recited in claim 14 wherein the processor controlled device includes a GPS navigation device, wherein the geographic location information retrieved from the processor controlled device is GPS navigation information read from the GPS navigation device integrated into the processor controlled device, wherein the GPS navigation information read from the GPS navigation device includes GPS coordinates of the processor controlled device that can be used to calculate the geographical location of the processor controlled device.

17. The system recited in claim 14 wherein the processor controlled device includes a phone capable of cellular communication, wherein the geographic location information retrieved from the processor controlled device is cellular tower information from cellular towers in vicinity to the processor controlled device and wherein the cellular tower information is used to calculate the geographic location of the processor controlled device.

18. The system recited in claim 14 wherein the resource provider is a support center and the resource being provided to the processor controlled device is access to an operator capable of speaking.

19. The system recited in claim 14 wherein the resource provider is a support center and the resource being provided is a visual display including written text wherein the text is in the language of communication.

20. A non-transitory computer readable medium having stored thereon sequences of instructions which when executed causes the processor controlled device to perform the steps of:
determining the at least one language of communication based on language communication information associated with the processor controlled device, wherein the language of communication information associated with the processor controlled device includes at least one of the following: geographic information, language file analysis information; and
transmitting the language of communication information from the processor controlled device to a resource provider, wherein the at least one language of communication is transmitted to the resource provider before resources are provided to the processor controlled device, wherein the resources assigned to the processor controlled device is in the at least one language of communication.
